(19) United States
(12) Patent Application Publication
(10) Pub. No.: US 2025/0274479 A1
(43) Pub. Date: Aug. 28, 2025

(54) FINGERPRINTING NETWORK SESSIONS FOR DISCOVERY OF CYBER THREATS

(71) Applicant: Vodafone Group Services Limited, Newbury (GB)

(72) Inventor: Christiaan Dawid Klopper, Pretoria (ZA)

(21) Appl. No.: 18/584,471

(22) Filed: Feb. 22, 2024

(51) Int. Cl. H04L 9/40

(52) U.S. Cl. CPC H04L 63/1441; H04L 63/1408

(57) ABSTRACT

A method for detecting cyberattacks in network communications includes collecting packet data in real time during the network communication, extracting relevant data from the collected data, positioning each packet in the relevant data to develop a fingerprint by creating an image containing blocks, colouring a block at the block position based on a value of each byte transmitted in the packet data, finding, by an artificial intelligence (AI) algorithm, by using the fingerprint in the image, as a threat level of a potential cyberattack in the collected data, and applying a countermeasure to the network communication based on the threat level of the potential cyberattack.

### FIELD OF THE INVENTION

The present application relates to computer systems, methods, and computer readable media generally for training and detecting cyber threats and particularly for fingerprinting network sessions for detecting cyber threats.

### BACKGROUND

Computers, tablets, servers, cloud servers, smart devices, and like computing systems (hereinafter collectively computers) have affected nearly every aspect of modern living. As computers have become widely used in everyday personal life and business operations, and data has been communicated through wireless or wired network in every aspect, cyber threats to the computers and to data saved in the computers and communicated through a network have correspondingly increased. Cyber threats encompass a wide range of malicious activities that aim to compromise the confidentiality, integrity, or availability of information systems and data.

Cybercriminals use various methods (e.g., malware, virus, etc.) to perform cyberattacks. In response, patches or other correcting measures have been used to generally address fixed patterns in conventional cyberattacks. Nevertheless, only a fraction of attacks are detected, namely, denial of service (DOS), exploits, fuzzers, generic, and reconnaissance attacks. Nowadays, cybercriminals have started using artificial intelligence (AI), BotNets, and generative adversarial networks (GAN) and have advanced their ability to perform highly sophisticated AI-assisted attacks that have become increasingly more difficult to discover, detect, and protect against the cyberattacks because their patterns dynamically vary based on situations.

Generally speaking, the cyber threat lifecycle stipulates the general tasks a cyber attacker needs to complete to infiltrate an organization. The key tasks are: during a reconnaissance task, a cyber attacker collects information and intelligence to aid the planned cyberattack; during a weaponization task, the collected information is used to improve the effectiveness of the cyberattack, during a delivery task, the cyberattack needs to successfully bypass the boundary safeguards such as intrusion detection defense systems; during a exploitation task, the cyberattack attempts to infiltrate the target organization's network; during an installation task, the cyberattack obtains a secure connection to open the organization's network for malicious attacks; during a command & control task, the cyber attacker has remote control of the organization's network; and during an actions task, the cyber attacker executes the intended malicious activity. AI-assisted attacks have been developed in every task and have evolved to highly targeted, undetectable malware that automatically exploits vulnerabilities in existing cyber defense systems.

Further, so-called zero-day attacks are a currently spreading cyberattack. Zero-day attacks refer to a situation where a large organization or an anti-virus company has discovered a vulnerability for which there are zero days to mitigate. With AI-assisted cyberattacks within the cybersecurity domain, “zero-day attacks” will be extended to the time when new advancements in new cyber threats are discovered. The most notable example is ransomware. In 2021, ransomware attacks increased by 92.7%. This is likely due to the increased use of more advanced machine learning (ML) and deep learning (DL) techniques that make new ransomware malware more undetectable. Thus, there is a room for improvement in detecting and identifying cyberattacks.

The subject matter claimed herein is not limited to aspects that solve any problems described above. Rather, this background is only provided to illustrate one exemplary technology area where some problems, which described subject matter herein, could solve.

### BRIEF SUMMARY

Disclosed aspects include a method for detecting cyberattacks in network communications. The method includes collecting packet data in real time during the network communication, extracting relevant data from the collected data, positioning each packet in the relevant data to develop a fingerprint, by creating an image including blocks, colouring each block at the block position based on a value of each byte transmitted in the packet data, finding, by an artificial intelligence (AI) algorithm, by using the fingerprint in the image, a threat level of a potential cyberattack in the collected data, and applying a countermeasure to the network communication based on the threat level of the potential cyberattack.

Disclosed aspects also include an apparatus for detecting cyberattacks in network communications. The apparatus includes a network communication circuitry for relaying data packets from a source to a destination, one or more processors, and a memory including instructions. The instructions, when executed by the one or more processors, cause the apparatus to collect packet data in real time during the network communication, extract relevant data from the collected data, position each packet in the relevant data to develop a fingerprint, by creating an image including blocks, colour each block at the block position based on a value of each byte transmitted in the packet data, find, by an artificial intelligence (AI) algorithm, by using the fingerprint in the image, a threat level of a potential cyberattack in the collected data, and apply a countermeasure to the network communication based on the threat level of the potential cyberattack.

Disclosed aspects also include a non-transitory computer-readable medium, which includes instructions that, when executed by a computer, cause the computer to perform a method for detecting cyberattacks in network communications. The method includes collecting packet data in real time during the network communication, extracting relevant data from the collected data, positioning each packet in the relevant data to develop a fingerprint by creating an image containing blocks, colouring each block at the block position based on a value of each byte transmitted in the packet data, finding, by an artificial intelligence (AI) algorithm, by using the fingerprint in the image, a threat level of a potential cyberattack in the collected data, and applying a countermeasure to the network communication based on the threat level of the potential cyberattack.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific aspects which are illustrated in the appended drawings. Understanding that these drawings depict only typical aspects and are not therefore to be considered to be limiting in scope, aspects will be described and explained with additional specificity and detail through the use of the accompanying drawings.

FIG. 1 illustrates a diagram for data communications through a network with potential cyberattacks according to various aspects of the present disclosure.

FIG. 2 illustrates a bar graph of statistical results of various cyberattacks.

FIG. 3 illustrates an example of conversion from a series of one-dimensional (1D) data to a two-dimensional image according to various aspects of the present disclosure.

FIG. 4 illustrates an example of two-dimensional images converted from a series of 1D data according to various aspects of the present disclosure.

FIG. 5 illustrates a tornado diagram for data packets in network communication according to various aspects of the present disclosure.

FIG. 6 illustrates fingerprints of backdoor attacks through network ports during network communication according to various aspects of the present disclosure.

FIG. 7 illustrates fingerprints of worm attacks through network ports during network communication according to various aspects of the present disclosure.

FIG. 8 illustrates an example of an image generated from transmitted data according to various aspects of the present disclosure.

FIG. 9 illustrates a flowchart for a method for training AI algorithm to identify potential cyberattacks according to various aspects of the present disclosure.

FIG. 10 illustrates a flowchart for a method for detecting potential cyberattacks based on fingerprints according to various aspects of the present disclosure.

FIG. 11 illustrates a block diagram for a computing device according to various aspects of the present disclosure.

### DETAILED DESCRIPTION

Disclosed aspects include systems, methods, and computer readable media for training an AI algorithm to identify potential cyberattacks and detecting potential cyberattacks based on fingerprints of the cyberattacks. Due to recent AI-based or assisted cyberattacks, patterns of cyberattacks have become dynamic. Thus, the challenge is that rule-and-anomaly-based intrusion detection approaches would also need to be evolved into a dynamic self-learning approach before being able to discover “undetectable” network threats. When considering current state-of-the-art network cybersecurity countermeasures, this has not yet been achieved and one of challenges in achieving this is the inability to extract meaningful information from network packets. The present disclosure addresses these problems by using fingerprints to detect potential cyberattacks and extract meaningful information from network packets.

Each fingerprint is represented by a two-dimensional matrix that may be visualized, and include a unique session key, a protocol discourse and the transmitted data. This is achieved by extracting information, summarising network session key events, encoding the received data, and merging it with existing fingerprints. The unique key and transmitted data are encoded using a space filling curve, while the protocol discourse is encoded into a tornado diagram. The resulting visualised network session fingerprints reveal hidden patterns that are for subsequent pattern recognition, reinforcement learning (RL) or support vector machines (SVM) training to discover AI-enhanced cyber threats as they evolve.

Based on the fingerprints as disclosed herein, AI-assisted cyber threats can be detected. Further, as AI-assisted cyber threats evolve, corresponding detection methods using fingerprints may be able to detect even the evolved AI-assisted cyber threats in real time because the fingerprints can be identified in real time at the data packet level.

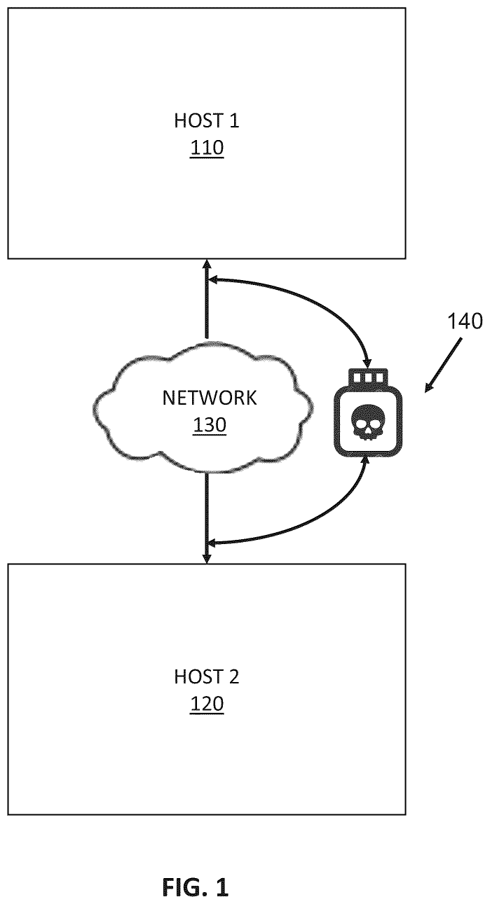

As illustrated in FIG. 1, data communications is shown with cyber attacker 140 between a first host 110 and a second host 120 via a network 130. The hosts 110 and 120 may be any personal/business computers, tablets, servers, smart devices, Internet of Things (IoTs), or any Internet-capable computing devices. The network 130 may be a mobile network, a wide area network (WAN), a local area network (LAN), or any other communication network. Communication protocol may be hypertext transfer protocol (HTTP), simple network management protocol (SNMP), file transfer protocol (FTP), transmission control protocol/Internet protocol (TCP/IP), simple mail transfer protocol (SMTP), or any other communication network protocol.

Based on the network protocol, a communication port may be determined. For example, ports 20 and 21 may be used for transferring files between two hosts when FTP is used. Port 25 may be used when SMTP is used for emails. Port 80 may be used for data communication on the Internet, thereby making the World Wide Web possible when HTTP is used.

The data communication may be initiated by either one of the two hosts 110 and 120. One or more routers (not shown), switching devices, or the likes (e.g., collectively network equipment) are positioned between the two hosts 110 and 120 and guide data packets to and from the two hosts 110 and 120. An initiating host prepares data packets and transmits to network equipment, which guides and directs to the destination host. Likewise, a receiving host receives the data packets, which have been guided and directed by the network equipment.

In this regard, the cyber attacker 140 can attack the network communication to compromise the data packets and/or network equipment. Specifically, the cyber attacker 140 attacks the data communication at the initiation host and/or at the receiving host and/or the network equipment. Based on vulnerability analyses, the cyber attacker 140 focuses on weak spots in the data communications.

The cyber attacker 140 may employ various kinds of cyberattacks, which include analysis, backdoors, denial of service (DOS), exploits, fuzzers, generic, reconnaissance, shellcode, worms, and AI-assisted threats (e.g., smart malware, MalGan, Daxin, etc.). This list is not meant to be limiting, but is provided to show some known examples of cyberattacks. The list can include any other attacks readily appreciated by people in cyber security areas. For example, by using the analysis, the cyber attacker 140 tests and analyzes to identify vulnerabilities at any entry point for cyberattacks. The exploit approach is to exploit vulnerabilities in software or hardware, the shellcode approach is to execute malicious code to exploit vulnerabilities, and the worm approach exploit vulnerabilities by infiltrating self-replicating and rapidly spreading malicious codes.

Regarding the AI-assisted threats, smart malware is an example of a path finding adversarial attack, which identifies failure incidents of computing systems, key infrastructure based on cooling capacity, and dynamically infers measurements that would result in erroneous responses leading to system wide failures. MalGan is an example of a block box adversarial attack, which trains a substitute detector to fit the black-box detection algorithm, generates adversarial samples upon detection, generates new adversarial samples to remain undetectable, and thus is able to successfully bypass a black-box malware detector. Daxin is an example of a positioning adversarial attack, which penetrates highly secured networks, implement C2 communications while hiding in legitimate TCP/IP communication streams, and seizes any packets or generate its own network packets to transmit.

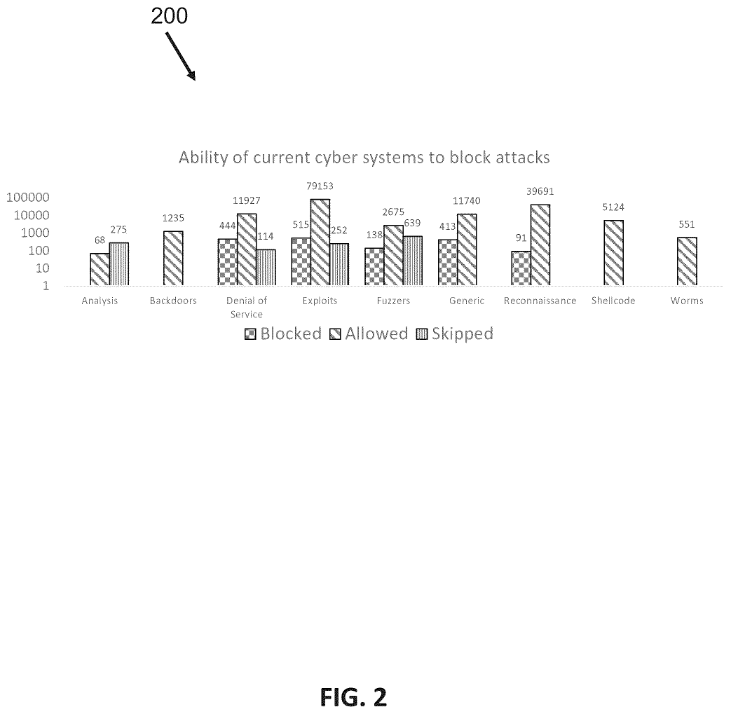

To see how much cyber defense has been protecting computer systems against cyberattacks, FIG. 2 illustrates a bar graph 200 showing simulation results of various cyberattacks made to a computer system based on traditional rule and anomaly threat detection as a cyber defense. The horizontal axis represents types of cyberattacks and the vertical axis represents numbers of count in logarithmic scale. The bar graph 200 includes histograms, which have different shades, which includes check-shapes, diagonal lines, and vertical lines. The check-shapes indicate blocked cyberattacks, the diagonal lines indicate skipped cyberattacks, and the vertical lines indicate allowed cyberattacks. Skipped cyberattacks mean that the cyberattacks are not selected for analysis and are undetected, allowed cyberattacks mean that the cyberattacks are analyzed but allowed to the computer system, and blocked cyberattacks means that the cyberattacks are analyzed, detected, and blocked to the computer system.

For example, with regard to the analysis type cyberattacks, 275 cyberattacks were skipped to the computer system and 68 cyberattacks were allowed. In other words, all of the 343 analysis type cyberattacks were undetected and unblocked. Likewise, all of the backdoors type cyberattacks, shellcode type cyberattacks, and worms type cyberattacks were undetected and unblocked. With respect to the denial of service (DOS) type cyberattacks, 515 cyberattacks were blocked, 79,153 cyberattacks were allowed, and 252 cyberattacks were skipped. Thus, only 3.7% of the DoS type cyberattacks were blocked and 96.3% were undetected and unblocked. Similarly, 0.6% of the exploits type cyberattacks were blocked and 99.4% were undetected and unblocked, 4.2% of the fuzzers type cyberattacks were blocked, 3.5% of the generic type cyberattacks were blocked, and 0.2% of the reconnaissance type cyberattacks were blocked. Thus, based on the bar graph 200, the traditional rule and anomaly threat detection as a cyber defense is considered as being unable to successfully detect cyberthreats.

Furthermore, AI-assisted and -enhanced cyberattack methods have been developed. For example, smart Malware is a self-learning malware that can deploy malicious attacks, while it seems like accidental failures by manipulating control systems. Smart Malware represents advancements in AI-targeted reconnaissance.

MalGAN is an algorithm based on a GAN that generates adversarial malware to bypass black-box malware detection systems. MalGAN can, upon detection, generate new malware examples to remain undetectable. DeepDGA is a next-generation approach to bypass domain name detection systems based on deep neural networks (DNN). Both MalGan and DeepDGA represent advancements in AI-concealed delivery.

DeepLocker is an extremely targeted evasive malware and only deploys once it confirms its target. No defenses have been implemented against DeepLocker. DeepLocker represents advances in AI-multilayered C2.

AI-enhanced attacks have evolved to highly targeted, undetectable malware that automatically exploits vulnerabilities in existing cyber defense systems. Therefore, with cyber threats evolving with AI-assistance across every phase of the cyber threat lifecycle, cyber defense systems require significant improvements to improve efficacy in networks in general. The challenge is that rule and anomaly based intrusion detection approaches would need to be evolved into a dynamic self-learning approach, which is capable of reacting to dynamically changing threats in real time.

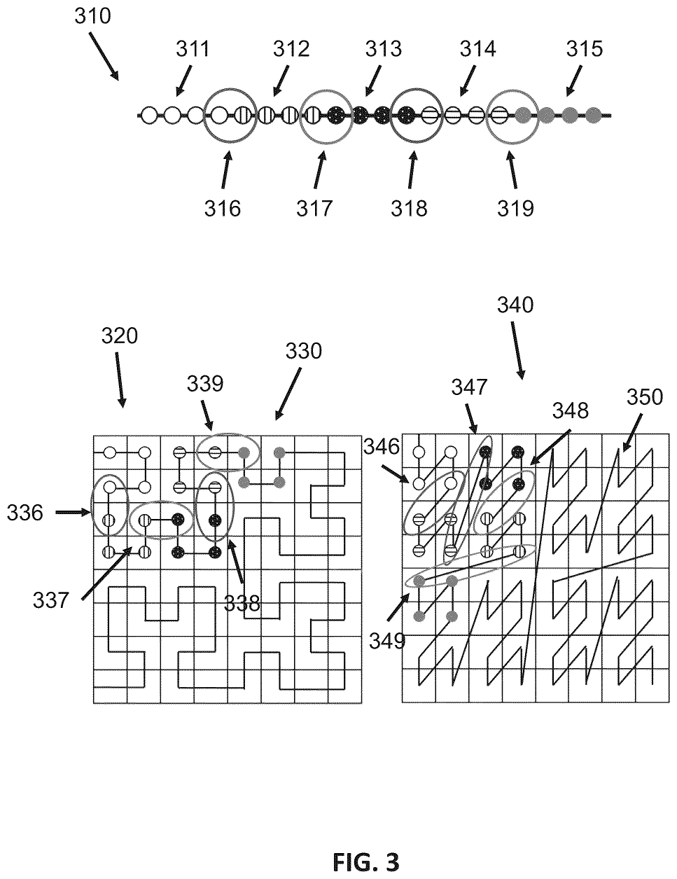

In this regard, disclosed are approaches in detecting dynamically changing cyberattacks in real time. One such approach is to convert a series of one-dimensional (1D) data transmitted within packets into a two-dimensional image as illustrated in FIG. 3 by using a space filling curve. When packets are received through a network the data within is sequential representing a 1D shape as illustrated in 310, the data packets may be grouped based on a number of bits or bytes (hereinafter “data unit”), which may be four, eight, sixteen, or other powers of two. In FIG. 3, four data units are used to group the 1D data packets 310. Without losing generality and in an effort to simplify the explanation, 20 data units are displayed in the 1D data packets 310 and grouped into five groups 311-315.

The 1D data packets 310 may be converted to 2D images 320 or 340 by using space-filling curves 330 and 350, respectively. Space filling curve 330 is a Hilbert mapping curve and space filling curve 350 is a Morton mapping curve. Hilbert and Morton mapping curves are provided as examples and any other space filling curves, which are readily appreciated by persons having skill in the art, may be used instead.

As described above, the 1D data units 310 of 20 data units are grouped by four data units to form five groups 311-315. Adjacent data units between adjacent groups are circled to show preservation of adjacency. Specifically, one data unit in group 311 and another data unit in group 312 are adjacent to each other and the two adjacent data units 316 are circled. Likewise, two adjacent data units 317-319 between adjacent groups are circled. When each data unit is mapped to or positioned at a group of pixels in the image 320, the adjacent data units 316-319 are mapped to adjacent groups 336-339 of pixels in the image 320, respectively. In other words, the Hilbert mapping curve 330 preserves adjacency in the 1D data packets 310 in the image 320 because the Hilbert mapping curve 330 moves straight to the bottom, the top, the left, or the right. Further, based on the Hilbert mapping curve 330, the 1D data packets 310 may be mapped to or positioned within a pixel of a group of pixels in the images 320 and 340.

On the other hand, the Morton mapping curve 350 moves straight to the left or diagonally to the bottom-left and to the top-right. When two adjacent data units correspond to the bottom-left or the top-right, the corresponding groups of pixels are further separated than the other adjacent data units in the 1D data packets 310. For example, adjacent data units 356 are more separated than the first two data units in the image 340. Also, adjacent data units 337 and 339 are further separated than the adjacent data units 356. Thus, the Morton mapping curve 350 does not preserve the adjacency in the 1D data packets 310 in the image 340.

Due to the preservation of the adjacency, the Hilbert mapping curve 330 is used in the description below. That does not, however, mean that any other space filling curve cannot be used in mapping 1D data packets to an image. Rather, based on requirements, other space filling curves may be used in mapping from or positioning 1D data packets to one or more pixels in an image.

With regard to positioning, the Hilbert mapping curve 330 positions the fourth data unit of the group 311 at a group of pixels at the second row and the first column of the image 320; the third data unit of the group 312 at a group of pixels at the fourth row and the second column; the second data unit of the group 314 at a group of pixels at the second row and the third column; and the first data unit of the group 315 at the first row and the fifth column in the image 320. Thus, the Hilbert mapping curve 330 dictates a position in the image based on the position in the 1D data packets.

Now, collection of data packets is described here to generate the 1D data units 310. Capturing and analyzing all data packets for identifying cyberattacks during network communications may be impractical because there are many formal and not-important data within packets (e.g., time-to-live (TTL), checksum (chksum), etc.), which are less meaningful compared to the substance of the network communication. Formal but important information in data packets may include source and destination addresses and ports, the length of the packets, the flags identifying the type of packet, and the content of each packet. These pieces of information may be captured from data packets. Captured data packets may be stored in a file. The format of the file is PCAP or any other format for storing captured packets.

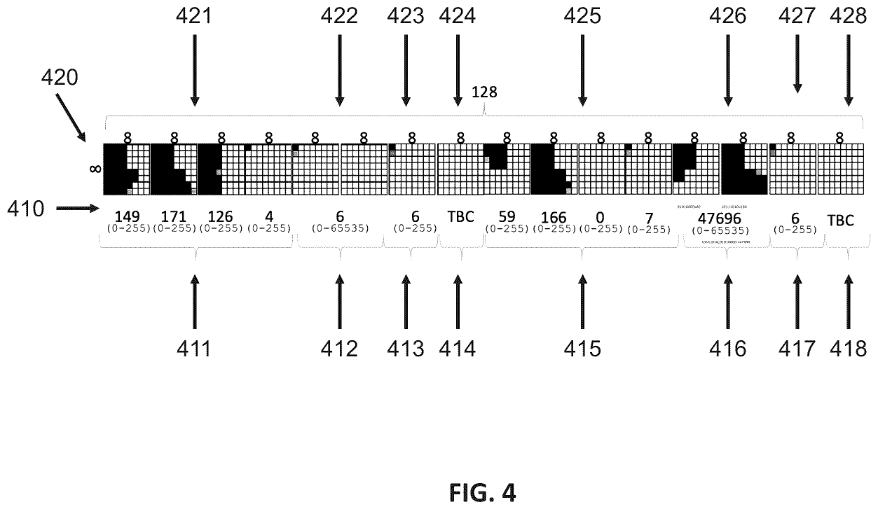

Since every network communication needs to know source and destination IP addresses and protocols, these pieces of information are extracted from the PCAP data. Specifically, they are saved in a header section. Now, conversion between bits in the header section 410 and levels of shade in pixels of an image 420 is described as illustrated in FIG. 4.

The header section 410 may include eight parts: source IP address 411, source port 412, source protocol 413, and a reserved part 414 in the source side information; and destination IP address 421, destination port 422, destination protocol 423, and a reserved part 424 in the destination side information. The source IP address 411 may have 4 bytes according to Internet Protocol version 4 (IPV4) format. Each byte has 8 bits, which can have a value ranging from 000000002, which is zero, to 111111112, which is 255. As illustrated, the source IP address 411 is 149.171.126.4 or 10010101.10101011.11111102.100 in binary number form, or 95.AB.7E.4 in hex number form. As such, the header section 410 shows that packet data pertains to a network communication from the source IP address 149.171.126.4 on port 4 through protocol 6 and to the destination IP address 59.166.0.7 on port 47696 through protocol 6. Based on this configuration, the size of the header section 410 is calculated from 16 bytes of information.

In aspects, in a configuration that the IP address follows Internet Protocol version 6 (IPV6) format, the size of the header section 410 may vary depending on the respective requirements. Correspondingly, the size of the header section 410 and the size of the corresponding image 420 may vary.

Not every protocol includes port numbers. For example, Internet Control Message Protocol (ICMP) does not require a port number for communications. Thus, the header section 410 may require source and destination IP addresses 411 and 416, and source and destination protocols 413 and 417.

After each data unit (e.g., 2 bits in this example) is positioned in the image 420 by following the space filling curve, each pixel in the image 420 may be coloured or shaded. Two bits can represent four different numbers from zero to three and can be assigned to two-by-two pixels in the two-dimensional (2D) image. Each pixel in the 2D images may have four different levels of shade. Thus, eight-by-eight pixels may be able to represent 256 different numbers represented by two bits per pixel. To simplify the explanation, with two-by-two pixels, the first pixel is one in the first row and the first column, the second pixel is one in the first row and the second column, the third pixel is one in the second row and the second column, and the fourth pixel is one in the second row and the first column by following the first four of the Hilber mapping curve. The following table shows how sixteen different binary numbers represented by four bits are assigned to levels of shade in the two-by-two pixels.

Conversion Table

| 4 bits in binary | Levels of Shade | | | |
|---|---|---|---|---|
| form | 1^{st} Pixel | 2^{nd} Pixel | 3^{rd} Pixel | 4^{th} Pixel |
| 0000 = 0 | 1 | 0 | 0 | 0 |
| 0001 = 1 | 2 | 0 | 0 | 0 |
| 0010 = 2 | 3 | 0 | 0 | 0 |
| 0011 = 3 | 4 | 0 | 0 | 0 |
| 0100 = 4 | 4 | 1 | 0 | 0 |
| 0101 = 5 | 4 | 2 | 0 | 0 |
| 0110 = 6 | 4 | 3 | 0 | 0 |
| 0111 = 7 | 4 | 4 | 0 | 0 |
| 1000 = 8 | 4 | 4 | 1 | 0 |
| 1001 = 9 | 4 | 4 | 2 | 0 |
| 1010 = 10 | 4 | 4 | 3 | 0 |
| 1011 = 11 | 4 | 4 | 4 | 0 |
| 1100 = 12 | 4 | 4 | 4 | 1 |
| 1101 = 13 | 4 | 4 | 4 | 2 |
| 1110 = 14 | 4 | 4 | 4 | 3 |
| 1111 = 15 | 4 | 4 | 4 | 4 |

As shown above in the Conversion Table, in every pixel with the value of four is shaded with the colour of the 4th level. If the value to be encoded is 14, the fourth pixel have the 3^{rd} level of shade. In another aspect, if the value to encode is 15, the fourth level of shade fill is used for the 4^{th} pixel when the 4 bits are 1111. Likewise, in an image with 128*128 pixels, the last pixel based on a space filling curve can be filled with at most the fourth level of shade.

The shade may be of gray or a colour, such as orange, yellow, green, cyan, blue, etc. In an aspect, the shade may be hue, luminance, tint, or tone. In another aspect, each pixel may have 64 different levels of shade so that two-by-two pixels can represent 256 different values, meaning that the two-by-two pixels may represent a group of 8 bits. In a still further aspect, each pixel may represent any number, which is not a power of two and the corresponding number of colours, shades, hues, luminances, tints, or tones may fill the pixel. In a still further aspect, the image, to which data packets are converted, may have pixels having a power of two on one side. In other words, the image may have a square shape with 2*2 pixels, 4*4 pixels, 8*8 pixels, . . . , 128*128 pixels, or the like. In a case where the total number of the data packets cannot fill the image, the remaining portions of the image may be left blank or displayed white or any other colour.

In another aspect, the image or a map may have a two-dimensional (2D) shape, such as a square, rectangular, or any other shape. Further, the image or the map may have a three-dimensional (3D) shape, for example, a cube, a solid in any shape other than a square, or any other 3D shape. In this regard, an appropriate space filling curve including the Hilbert mapping may be utilized. In still other aspect, the dimension of the image or the map may be greater than three, and an appropriate space filling may be used.

Now referring back to the source IP address 411, the first address number is 149. Since each pixel can have 4 different levels, 149 can make 37 pixels 4^{th} level and 38^{th} pixel can have the first level of shade because 149=4*37+1. Thus, the first 8*8 pixels 421 of the image 420 corresponding to the first number of the source IP address 411 have the first 38 pixels, which follow the Hilbert mapping curve, with the 4^{th} level of shade and the 39^{th} pixel with the 1^{st} level of shade. Likewise, the second 8*8 pixels 422 of the image 420 corresponding the second number of the source IP address 412 has the first 42 pixels with the 4^{th} level and the 43^{rd} pixel with the 3^{rd} level of shade because 171=4*42+3.

As illustrated in FIG. 4, the source port 413 and the destination port 416 have 2 bytes so that the port number can range from 0 to 65535. Since two 8*8 pixels cannot represent 65535, the lowest one byte of each of the port 413 and 416 is mapped to the first 8*8 pixels of the two 8*8 pixels 422 and 426, and the highest one byte of each of the port 413 and 416 is mapped to the second 8*8 pixels of the two 8*8 pixels 422 and 426, respectively. As such, the two 8*8 pixels 422 has the first 8*8 image based on the lowest one byte, that is “6” and the second 8*8 pixels has no shade because “6” does not have the highest one byte. On the other hand, the destination port 416 is 47696, which is 1011101001010000. Thus, the lowest one byte is 01010000, which is 80, and the highest one byte is 10111010, which is 186. Hence, the first 20 pixels have the 4^{th} level of shade in the first 8*8 pixels of the two 8*8 pixels 426, and the first 46 pixels have the 4^{th} level of shade and the 47^{th} pixel has the 2^{nd} level of shade.

In this way, the image 420, which has 8*128 pixels, is generated from 16 bytes of source information. The way how to shade each pixel in the image 420, as described above, is provided as an example and can be any other way, which persons having skill in the art would readily appreciate for shading each pixel.

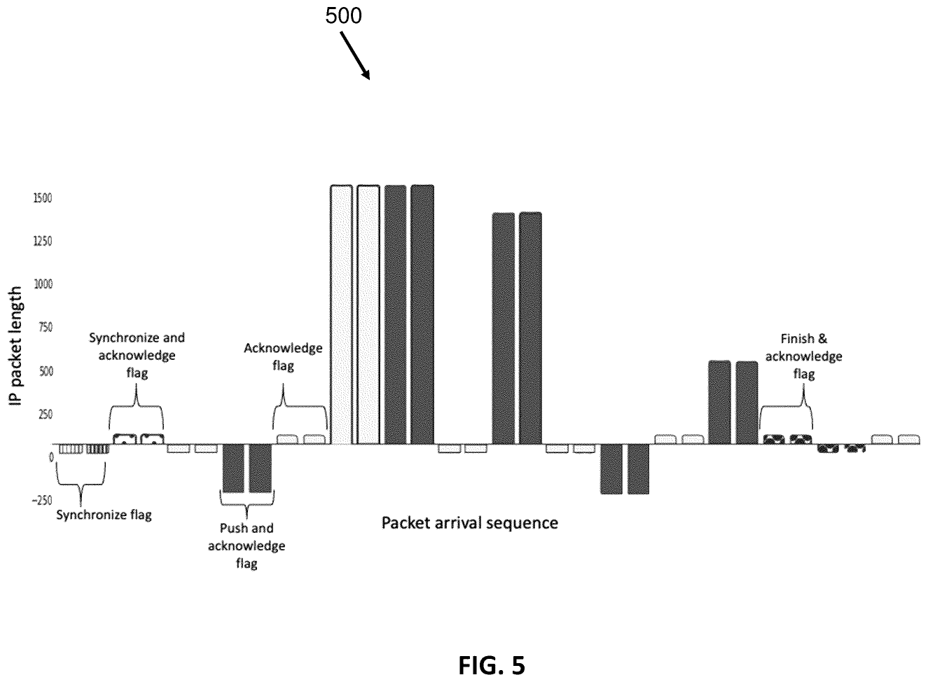

Further, PCAP data may include other relevant data, such as lengths of data packets exchanged between the source host and destination host with associated flags. FIG. 5 illustrates a tornado diagram or protocol discourse section 500 for data packet exchanges between the source and destination hosts. For example, this data communication is a TCP session between 59.166.0.7 on port 53421 and 149.171.126.4 on port 80. The horizontal axis represents time of packet arrival sequence, and the vertical axis represents IP packet lengths.

When the network communication was started, a synchronization flag was sent by one host and a synchronization acknowledgement flag was sent in response by the other host. Similarly, when the network communication was finished, a finish flag was communicated by one host and a finish acknowledgement flag was communicated by the other host. Data packets were exchanged during the network communication between the two hosts. As illustrated, the length of the data exchange is comparatively greater than the length of the flags. The protocol discourse section 500 portrays the exchange of data packets between the source and destination hosts for every network session and may add characteristics and behaviour of the communication between the source and destination hosts to the fingerprint which will be described below in consideration of training and detecting potential cyberattacks.

With the image conversion from data packets by using a space filling curve as described above, an artificial intelligence (AI) or machine learning (ML) algorithm may be trained to identify potential cyberattacks with training data sets. For example, there are publicly available PCAP data sets as training data sets, which include raw PCAPs with labels of cyberattacks (e.g., DoS, worms, backdoors, fuzzers, zero day attacks amongst other threats). In addition, the training dataset may contain labels of categories of threats rather than actual attacks with threat levels thereof. The threat levels may be benign or malicious.

With the training data sets, relevant data may be gathered. For example, the header section information is extracted per each network communication and the corresponding images are generated as described above with respect to FIG. 4. Also, based on the lengths of data exchange, the protocol discourse section is also generated as described above with respect to FIG. 5. Further, communicated or transmitted data per the communication is also extracted to generate an image by using a space filling curve (e.g., a Hilbert mapping curve, Morton mapping curve, etc.).

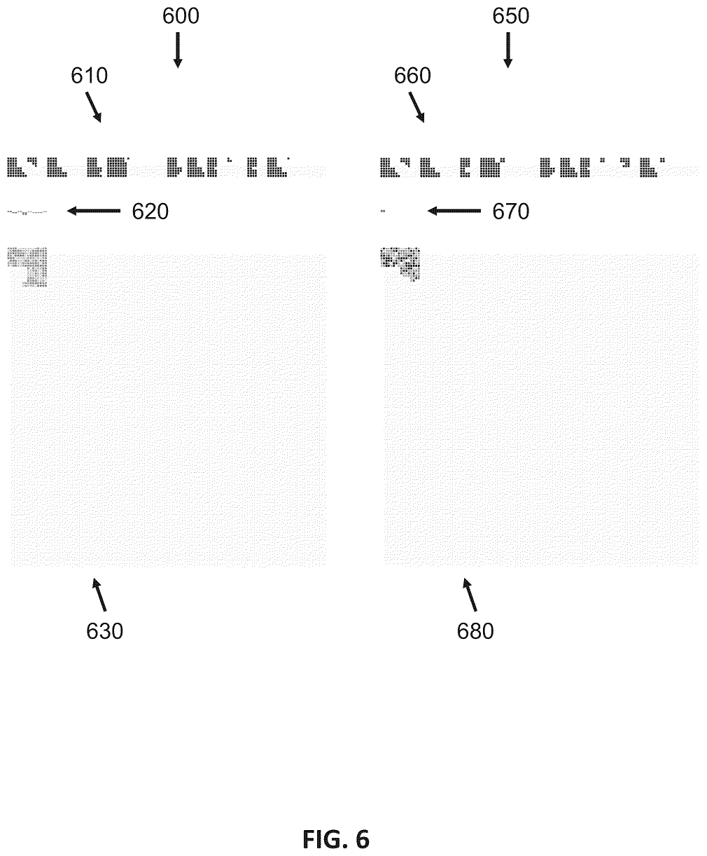

FIG. 6 illustrates two images 600 and 650 generated from two network communications. The images 600 and 650 include header sections 610 and 660, protocol discourse sections 620 and 670, and transmitted data images 630 and 680, respectively. In particular, based on the header section 610, the network communication has been done through the TCP protocol on port 45947, and based on the label of the data packets, the cyberattack was identified as a backdoor and the threat level was malicious. Also, based on the header section 660, this network communication has been done through the user datagram protocol (UDP) on port 43830, and based on the label, this was not a cyberattack and was identified as a benign network communication.

The protocol discourse section 620 indicates that there was no substantial data exchange between two hosts. Thus, the transmitted data image 630 has only the top left portions with shades and the other portions are blank. Similarly, the protocol discourse section 670 indicates there was no data exchange between two hosts, and the transmitted data image 680 does not have much information except the top left portions. Since the header sections 610 and 660 have different information, the protocol discourse sections 620 and 670 have different shapes. Further, the transmitted data images 630 and 680 have different shades and different shapes, since the content transmitted by each have a difference sequence and value of bytes.

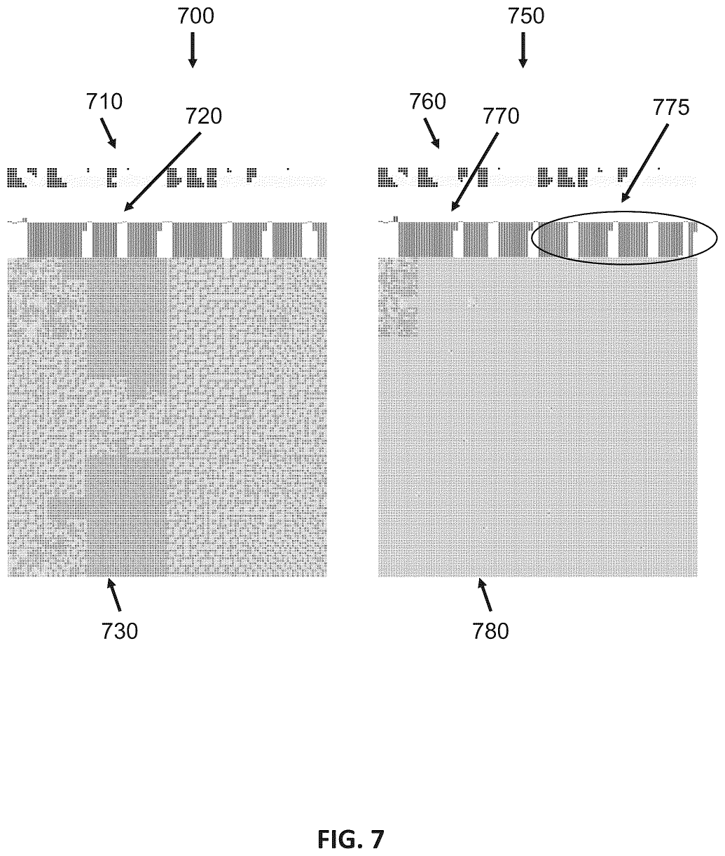

Another example of images generated from two network communications is illustrated in FIG. 7. The images 700 and 750 are generated from network communications exchanged between TCP on the host side and HTTP on port 80 on the receiver side. Both communications were attacked by a worm, while the threat level of the first image 700 is malicious and the threat level of the second image 750 is benign.

The protocol discourse sections 720 and 770 show a similar pattern in the first portion, while they show different patterns in the later portions (i.e., 775 of the protocol discourse section 770 and the corresponding portions of the protocol discourse section 720). That means the amount of data exchanges in the benign threat is different from the amount of data exchange in the malicious threat. Even though the first portions of the protocol discourse sections 720 and 770 have similar patterns, the submitted data images 730 and 780 do not have similar patterns in the corresponding portions because the protocol discourse sections 720 and 750 merely include length or size information of communicated data but not substance thereof. The AI algorithm may be able to find different patterns between benign and malicious threats not based on actual data itself but based on the amount or length of data exchanges. Further, the transmitted data images 730 and 780 may be used by the AI algorithm to find or identify fingerprints of the benign or malicious threats by the worm attack.

These processes are applied to all network sessions to generate corresponding images. By inputting the images (e.g., images 600 and 650) with the names of the cyberattack and the levels of threat into AI algorithm with reinforcement methodology, the AI algorithm can learn to find, identify, or detect fingerprints of cyberattacks and levels of threats in the data packet level based on image processing or black box processing within the AI algorithm. The fingerprints, which may not be found through conventional rule-based methods, can be found by image processing by AI or ML algorithm (hereinafter collectively the “AI algorithm”).

After the AI algorithm has been trained, the training data sets may be used for testing purposes as well. For example, a half of the data sets may be used for training the AI algorithm and the other half of the data sets may be used for testing purposes. Later in time, the testing data sets may be used to train the AI algorithm and the training data sets may be used to test the AI algorithm. In this way, one data set may be used for both testing and training purposes.

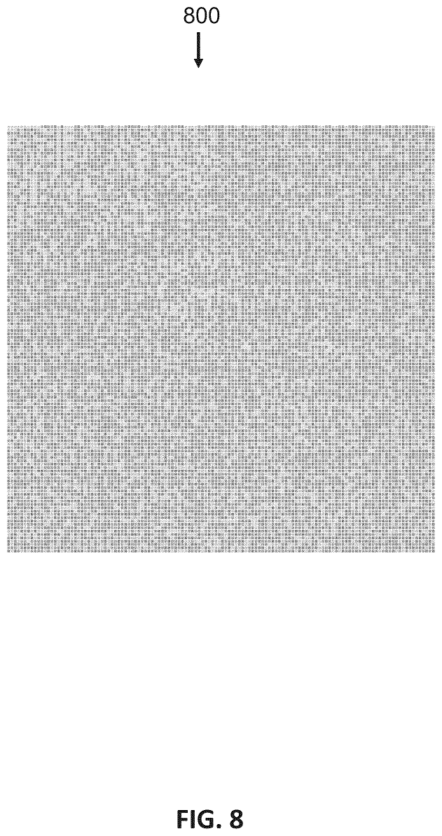

FIG. 8 illustrates an example of an image or map 800 generated from network traffic data other than the header or flags based on a space filling curve. Generally, the network traffic data may be a major content of data transmitted through the network communications. Thus, the network traffic data may be converted into one or more images of a unit image. In an aspect, the image 800 may have a fixed size, such as 128*128 pixels, or a various size depending on the size of the network traffic data.

In another aspect, the space filling curve used for the network traffic data may be different from the space filling curve used for the header and flags. Further, an AI algorithm to find one or more fingerprints in the image 800 may be different from an AI algorithm to find one or more fingerprints in the header of flags (e.g., the images of 630 and 680 of FIG. 6 or the image 730 and 780 of FIG. 7).

Furthermore, fingerprints may be identified in the temporal order. In other words, fingerprints found in the images of 630 and 680 of FIG. 6 or the image 730 and 780 of FIG. 7 may be followed by fingerprints found in the image 800 of FIG. 8. Newly found fingerprint may be added to previously found fingerprints in the temporal order, thereby expanding the fingerprint in real time.

In a still further aspect, data packets are not limited to network communication sessions. Rather, any data during accessing, reading, updating, or writing processing may be mapped into an image based on a space filling curve to generate one or more images (e.g., the images of 630 and 680 of FIG. 6, the images 730 and 780 of FIG. 7, or the image 800 of FIG. 8). Fingerprints may be identified at the local level. In this regard, fingerprints may be identified while reading or writing one or more files in any format.

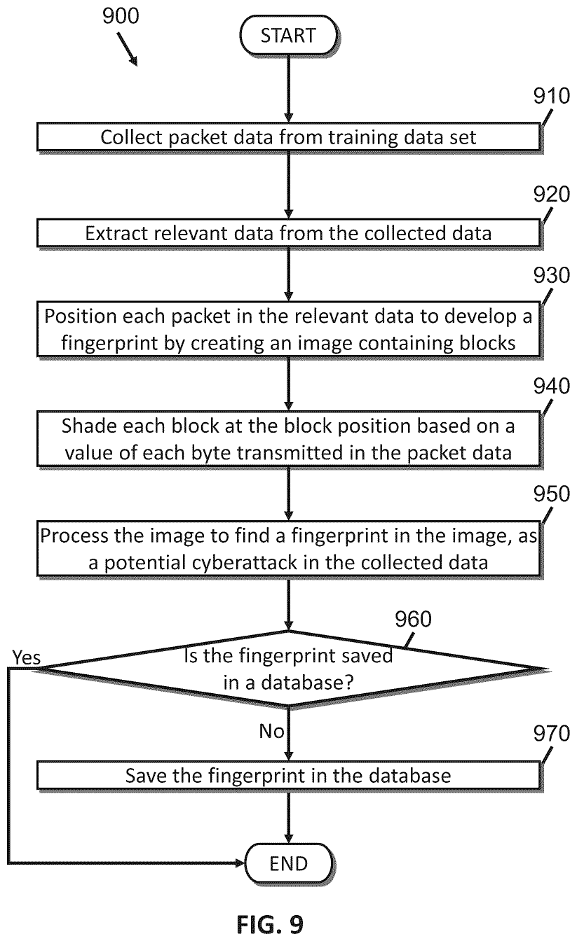

Turning now to FIG. 9, a flowchart for a training method 900 training an AI algorithm to identify potential cyberattacks is illustrated. The training method 900 may utilize supervised or unsupervised approach in training the AI algorithm. In an aspect, the training method 900 may employ a reinforcement learning approach to train the AI algorithm. To facilitate the training, the training method 900 may be performed by a computer including a plurality of graphical processing units (GPUs), which are capable of parallel processing, application specific integrated circuits (ASICs), or central processing units (CPUs).

One or more training data sets may be provided for training and include raw data packets, of which some are not related to network communications but exist therein due to requirements of the communication protocol or requirements. Further, the training data set contains labels of cyberattacks and threat levels thereof. In a case where there are no labels of threat levels, the training data set is preprocessed to add the threat levels of labeled cyberattacks. The threat level may be low-level, benign, or high-level, malicious.

At step 910, packet data may be collected from the training data set for a communication session. When two hosts communicate with each other, there may be two or more communication sessions. Thus, based on the IP addresses, ports, and protocols, one communication session may be specified, and any data packets transmitted in the communication session may be collected at step 910, and any other data packets for another communication session are not collected for the communication session.

At step 920, relevant data may be extracted from the collected data. Source IP address, source port, source protocol, destination IP address, destination port, and destination protocol may be portions of the relevant data. These pieces of information may form a header section to save source and destination information. Further, the header section may be used to find a fingerprint later. Further, transmitted data during the communication session may be also extracted at this step.

In the collected data, lengths of each tag and data exchanges may be collected to generate a tornado diagram or protocol discourse section. The protocol discourse section may graphically and intuitively show how much data is exchanged between two hosts from the start to the end of the communication session.

At step 930, the relevant data extracted from the collected data may be positioned in the relevant data to develop a fingerprint by creating an image containing blocks. In particular, the relevant data is a one-dimensional series of data, while the image has two-dimensional pixels. While mapping, a space filling curve may be employed. The space filling curve may be Hilbert mapping curve, Morton mapping curve, row-by-row mapping curve, column-by-column mapping curve, or any other mapping curve that is capable of converting a 1D series of data to a 2D image. In a case where adjacency of data is required to be preserved, the Hilbert mapping curve may be used in positioning 1D data at pixels of the image.

Based on the number of different shades in a pixel, a number of bits or bytes may be determined to be mapped to a block of pixels. For example, in a configuration that one pixel has four different shades, 1 byte of data may be mapped to 2*2 pixels by following the space filling curve.

At step 940, based on the numerical value of each byte transmitted in the collected or packet data, one or more pixels are shaded with different levels. The shade may be gray or colour including, but not limited to, orange, yellow, green, cyan, blue, etc. In another aspect, the shade may be hue, luminance, tint, or tone. In an aspect, the image, to which data packets are converted, may have pixels having a power of two in one side. In other words, the image may have 2*2 pixels, 4*4 pixels, 8*8 pixels, . . . , 128*128 pixels, or the like.

By performing positioning and shading or colouring at steps 930 and 940, the 1D series of data extracted from the collected data is mapped to and shaded in the pixels of the image. Further, adjacency of bits or bytes of the data is preserved in the image, thereby related data associated with cyberattacks may be shown close by in the image. In other words, any patterns hidden from conventional methods or rule-based methods could be found with the image with shades.

At step 950, the image is processed by the AI algorithm with the labels of cyberattacks and the threat levels. The AI algorithm may receive a higher weight when a fingerprint is found or identified in the presence of a label of cyberattacks and threat levels, thereby reinforcing the AI algorithm to be trained with emphasis.

At step 960, it is determined whether or not the identified fingerprint is saved in a fingerprint database. In a case when the identified fingerprint is saved in the fingerprint database, the analyzing of the data is finished. In another case when the identified fingerprint is new to the fingerprint database, the identified fingerprint is saved in the fingerprint database at step 970,

Step 910-970 are repeatedly performed for each network communication session in the training data sets until all relevant data packets are converted into images and all communication sessions are analyzed.

In an aspect, one half of the data set may be used for training the AI algorithm and the other half may be used to test the AI algorithm. The following may be a part of the training method 900. After training the AI algorithm with first half of the data, the AI algorithm analyzes the second half with the labels not considered. When there are false positives or false negatives, the AI algorithm is further trained with the corresponding data with the related labels. By doing this, one set of training data can be used for training and testing purposes.

Since the AI algorithm can be dynamically adapted to different situations and self-taught with new training data with corresponding labels, the AI algorithm may be ready for attacks from unknown parties or even newly generated/evolved attacks. Further, PCAP data can be captured from data packets, real time detection of cyberattacks may be realized.

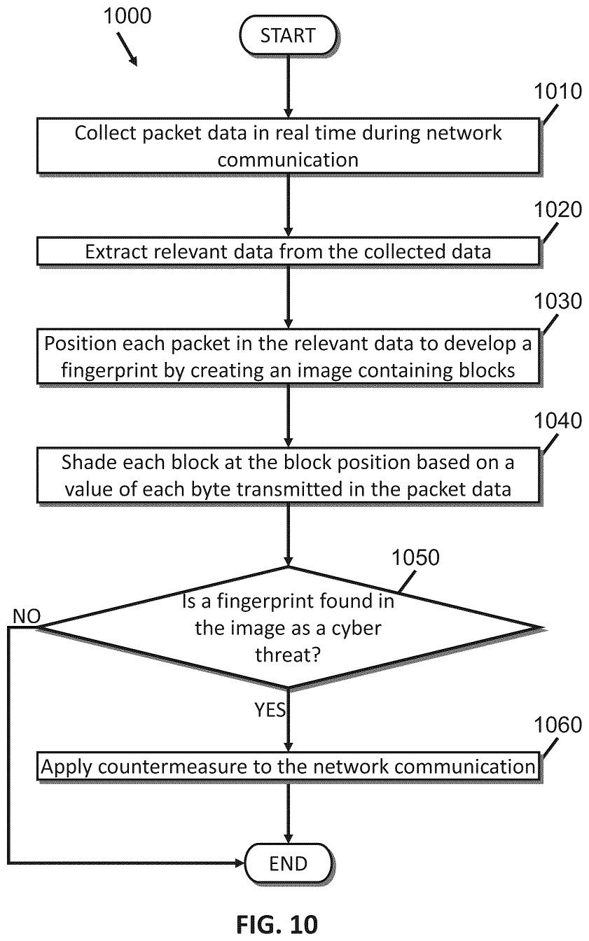

Now turning to detecting potential cyberattacks in real time, after the AI algorithm has been trained, the AI algorithm may be deployed to a computer, server, tablet, smart devices, or cloud computer to detect potential cyberattacks. A method 1000 for detecting cyberattacks is illustrated in FIG. 10. The method 1000 may be performed in real time right at the network communication, meaning that, when an attack is performed on or at one or more data packets, such attack may be detected during the network communication without a substantial delay. The AI algorithm may be deployed to check data packets transmitted to hardware (e.g., network equipment, such as a router, switching device, etc.) or software (e.g., an operating system, chatting programs, web browsers, etc.).

The method 1000 starts by collecting packet data in real time during a network communication at step 1010. Not every data packet may be captured but relevant data packets may be captured. For example, data packets, which pertains only to the network communication and no other communication, are captured or collected. For example, if a network communication is from IP address 149.171.126.4 through TCP on port 6 to IP address 59.166.0.7 on port 47696 through UDP, data packets transmitted from IP address 149.171.126.4 through TCP on port 6 to IP address 59.166.0.7 on port 47696 through UDP are captured. If an IP address, a port, or a protocol is different, such data packets are not captured for the network communication at step 1010.

From the collected data, relevant data may be extracted at step 1020. The relevant data may include sizes of network tags (e.g., synchronization tags, acknowledgment tags, push tags, finish tags, finish acknowledgment tags, etc.) and a size of transmitted data in a chronological, or any other order. The size information may be used to generate a protocol discourse section in a tornado diagram format. The protocol discourse section may provide chronological trends of data exchange so as to help determine presence of a fingerprint in the collected PCAP data.

Similar to step 930 of the method 900, at step 1030, the relevant data extracted from the collected data may be positioned in the relevant data to develop a fingerprint by creating an image containing blocks. In particular, the relevant data is a one-dimensional series of data, while the image has two-dimensional pixels. While mapping, a space filling curve, such as Hilbert mapping curve, Morton mapping curve, raw-by-raw mapping curve, column-by-column mapping curve, or any other mapping curve, may be employed to position a 1D series of data to one or more appropriate pixels in a 2D or 3D image. In a case where adjacency of data is required to be preserved, the Hilbert mapping curve may be used in positioning data into pixels of the image.

At step 1040, each pixel in the image is shaded with an appropriate level according to each byte transmitted in the collected or packet data. As described above, when one byte is mapped to 2*2 pixels, each pixel can have four different shades so that the 2*2 pixels can have 16 different combinations of shades. For example, in a case when one byte data has 00001000 in binary form, two pixels are shaded with the 4^{th} level, when one byte data has 00001011 in binary form, two pixels are shaded with the 4^{th} level and the third pixel is shaded with the 3^{rd} level.

At step 1050, it is determined whether or not a fingerprint is found in the image as a cyber threat. In other words, the AI algorithm may compare the image with fingerprints saved in the fingerprint database. In a case where the AI algorithm find a match or substantially close match, the AI algorithm may determine that a fingerprint in the image is found at step 1050.

In response to the detection of the fingerprint, the AI algorithm may apply a countermeasure to the cyberattack at step 1060. For example, the AI algorithm may immediately stop communicating with the source IP address on the source port through the source protocol, automatically blocking data submitted from the source IP address on the source port through the source protocol, and/or generating a popup window to inform the user of the potential cyber threats and to receive a confirmation from the user the stopping the network communication. Further, the AI algorithm may register the source IP address on the source port through the source protocol in a blocked list so that the firewall or security system may be able to automatically block the communication based on the IP address.

In an aspect, the countermeasure may depend on the threat level. In a case where the threat level is benign, the countermeasure may be just informing the user of the potential cyberattacks and doing nothing unless otherwise instructed by the user. On the other hand, when the threat level is malicious, the countermeasure may be immediately automatically blocking the communication without the user's initiation first and informing the user of such next. In a case where it is determined that no fingerprint is found in the image, the method 1000 is ended for the PCAP data captured from the data packets per a communication session.

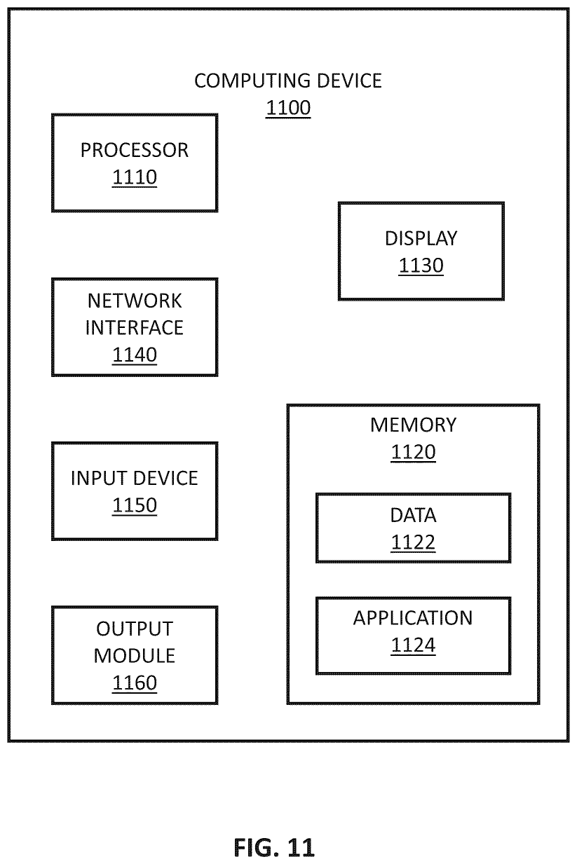

Turning now to FIG. 11, a simplified block diagram is provided for a computing device 1100, which can be implemented as the host computer or server 110 or 120 of FIG. 1, the fingerprint database computer, an AI testing or training computer, or any other computing devices. The computing device 1100 may include a processor 1110, a memory 1120, a display 1030, a network interface 1040, an input device 1050, and/or an output module 1060. The memory 1020 includes any non-transitory computer-readable storage media for storing data and/or software that is executable by the processor 1110 and which controls the operation of the computing device 1100.

The computing device 1100 may include an operating system configured to perform executable instructions. The operating system is, for example, software, including programs and data, which manages hardware of the disclosed apparatus and provides services for execution of applications for use with the disclosed apparatus. Those of skill in the art will recognize that suitable operating systems include, by way of non-limiting examples, FreeBSD®, OpenBSD, NetBSD®, Linux®, Unix®, Apple® Mac OS X Server®, Oracle® Solaris®, Windows Server®, Windows®, Novell®, NetWare®, iOS®, Android®, or any other operating system readily available. In some aspects, the operating system is provided by cloud computing.

The processor 1110 may be a general purpose processor, a specialized graphics processing unit (GPU) configured to perform specific graphics processing tasks (e.g., parallel processing for training and testing data packets for potential cyberattacks) while freeing up the general-purpose processor to perform other tasks, and/or any number or combination of such processors, digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

The memory 1120 may include one or more solid-state storage devices such as flash memory chips. Alternatively or in addition to the one or more solid-state storage devices, the memory 1120 may include one or more mass storage devices connected to the processor 1110 through a mass storage controller (not shown) and a communications bus (not shown). Although the description of computer-readable media contained herein refers to a solid-state storage, it should be appreciated by those skilled in the art that computer-readable storage media can be any available media that can be accessed by the processor 1110. That is, computer readable storage media may include non-transitory, volatile and non-volatile, removable and non-removable media implemented in any method or technology for storage of information such as computer-readable instructions, data structures, program modules or other data. For example, computer-readable storage media includes RAM, ROM, EPROM, EEPROM, flash memory or other solid state memory technology, CD-ROM, DVD, Blu-Ray or other optical storage, magnetic cassettes, magnetic tape, magnetic disk storage or other magnetic storage devices, or any other medium which can be used to store the desired information and which can be accessed by the computing device 1100.

The memory 1120 may store application 1124 (e.g., fingerprint database, AI algorithm, etc.) and/or data 1122 (e.g., fingerprints). The application 1124 may, when executed by processor 1110, cause the display 1130 to present the user interface to provide information to users. The application 1124 may be one or more software programs stored in the memory 1120 and executed by the processor 1110 of the computing device 1100. The application 1124 may be installed directly on the computing device 1100 or via the network interface 1140. The application 1124 may run natively on the computing device 1100, as a web-based application, or any other format known to those skilled in the art.

In an aspect, the application 1124 may include a sequence of process-executable instructions, which can perform any of the herein described methods, programs, algorithms or codes, which are converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, C, Delphi, Fortran, Java, JavaScript, python, machine code, operating system command languages, Pascal, Perl, PL1, scripting languages, Visual Basic, meta-languages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The display 1130 may be a cathode ray tube (CRT), a liquid crystal display (LCD), a thin film transistor liquid crystal display (TFT-LCD), and an organic light emitting diode (OLED) display. In certain aspects, the OLED display is a passive-matrix OLED (PMOLED) or active-matrix OLED (AMOLED) display. In aspects, the display 1130 is a plasma display, and a video projector. In various aspects, the display 1130 may be interactive (e.g., having a touch screen or a sensor such as a camera, a 3D sensor, etc.) that can detect user interactions/gestures/responses and the like so as to serve as both an input and output device.

The network interface 1140 may be configured to connect to a network such as a local area network (LAN) consisting of a wired network and/or a wireless network, a wide area network (WAN), a wireless mobile network, a Bluetooth network, and/or the internet.

For example, the computing device 1100 may process data packets from network communications, through the network interface 1140, generate images by using a space filling curve, and identify cyberattacks and levels of the threats. The computing device 1100 may update the AI algorithm, for example, the application 1124, via the network interface 1140. The computing device 1100 may also display images and any notification from training and/or testing on the display 1130.

The input device 1150 may be any device by means of which a user may interact with the computing device 1100, such as, for example, a mouse, keyboard, touch screen, and/or any other interface. The output module 1160 may include any connectivity port or bus, such as, for example, parallel ports, serial ports, universal serial busses (USB), or any other similar connectivity port known to those skilled in the art.

The aspects disclosed herein are examples of the disclosure and may be embodied in various forms. Although certain aspects herein are described as separate aspects, each of the aspects herein may be combined with one or more of the other aspects herein. It should also be understood that, depending on the example, certain acts or events of any of the processes or methods described herein may be performed in a different sequence, may be added, merged, or left out altogether (e.g., all described acts or events may not be necessary to carry out the techniques). In addition, Specific structural and functional details disclosed herein are not to be interpreted as limiting, but as a basis for the claims and as a representative basis for teaching one skilled in the art to variously employ the present disclosure in virtually any appropriately detailed structure.

In various aspects, the techniques described herein relate to a non-transitory computer readable medium including computer executable instructions that, when executed by a computer, cause the computer to perform a method for detecting cyberattacks in network communication.

The present invention may be embodied in other specific forms without departing from its spirit or characteristics. The described aspects are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for detecting cyberattacks in network communications, the method comprising:
collecting packet data in real time during the network communications;
extracting relevant data from the collected data;
positioning each packet in the relevant data to develop a fingerprint by creating an image containing blocks;
colouring each block at the block position based on a value of each byte transmitted in the packet data;
finding, by an artificial intelligence (AI) algorithm, by using the fingerprint in the image, a threat level of a potential cyberattack to the collected data; and
applying a countermeasure to the network communication based on the threat level of the potential cyberattack.

2. The method according to claim 1, wherein positioning each packet in the relevant data is performed based on a size of the image by a space-filling curve.

3. The method according to claim 2, wherein the space-filing curve is a Hibert curve.

4. The method according to claim 2, wherein the AI algorithm has been trained with a plurality of PCAP data and corresponding levels of malicious attacks via the space-filling curve.

5. The method according to claim 2, wherein the space-filling curve preserves adjacency between two packets in corresponding two block positions in the image.

6. The method according to claim 1, wherein colouring each block is additionally based on bars on communication flags and packet sizes.

7. The method according to claim 1, wherein the block has a predetermined number of pixels corresponding to a size of each packet.

8. The method according to claim 7, wherein each pixel has a predetermined number of gray scales or colours.

9. The method according to claim 1, wherein the relevant data includes information from a header, protocol disclosure, and transmitted data.

10. The method according to claim 1, further comprising:
when the fingerprint is not found in a fingerprint database, adding the fingerprint to the fingerprint database.

11. An apparatus for detecting cyberattacks in network communications, the apparatus comprising:
a network communication circuitry for relaying data packets from a source to a destination;
one or more processors; and
a non-transitory memory including instructions that, when executed by the one or more processors, cause the apparatus to:
collect packet data in real time during the network communications;
extract relevant data from the collected data;
position each packet in the relevant data to develop a fingerprint by creating an image containing blocks;
colour each block at the block position based on a value of each byte transmitted in the packet data;
find, by an artificial intelligence (AI) algorithm, by using the fingerprint in the image, a threat level of a potential cyberattack to the collected data; and
apply a countermeasure to the network communication based on the threat level of the potential cyberattack.

12. The apparatus according to claim 11, wherein positioning each packet in the relevant data is performed based on a size of the image by a space-filling curve.

13. The apparatus according to claim 12, wherein the space-filing curve is a Hibert curve.

14. The apparatus according to claim 12, wherein the AI algorithm has been trained with a plurality of PCAP data and corresponding levels of malicious attacks via the space-filling curve.

15. The apparatus according to claim 12, wherein the space-filling curve preserves adjacency between two packets in corresponding two block positions in the image.

16. The apparatus according to claim 11, wherein colouring each block is additionally based on bars on communication flags and packet sizes.

17. The apparatus according to claim 11, wherein the block has a predetermined number of pixels corresponding to a size of each packet.

18. The apparatus according to claim 11, wherein each pixel has a predetermined number of gray scales or colours.

19. The apparatus according to claim 11, wherein the instructions, when executed by the one or more processors, cause the apparatus to:
when the fingerprint is not found in a fingerprint database, add the fingerprint to the fingerprint database.

20. A non-transitory computer-readable medium, which includes instructions that, when executed by a computer, cause the computer to perform a method for detecting cyberattacks in network communications, the method comprising:
collecting packet data in real time during the network communications;
extracting relevant data from the collected data;
positioning each packet in the relevant data to develop a fingerprint by creating an image including blocks;
colouring each block at the block position based on a value of each byte transmitted in the packet data;
finding, by an artificial intelligence (AI) algorithm, by using the fingerprint in the image, a threat level of a potential cyberattack to the collected data; and
applying a countermeasure to the network communication based on the threat level of the potential cyberattack.
